(19) United States
(12) Patent Application Publication
(10) Pub. No.: US 2021/0304767 A1
(43) Pub. Date: Sep. 30, 2021

(54) MEETING SUPPORT SYSTEM, MEETING SUPPORT METHOD, AND NON-TRANSITORY COMPUTER-READABLE MEDIUM

(71) Applicant: Honda Motor Co., Ltd., Tokyo (JP)

(72) Inventors: Naoaki SUMIDA, Saitama (JP); Masaki NAKATSUKA, Saitama (JP); Kazuhiro NAKADAI, Saitama (JP); Yuichi YOSHIDA, Saitama (JP); Takashi YAMAUCHI, Saitama (JP); Kazuya Maura, Oita (JP); Kyosuke Hineno, Oita (JP); Syozo Yokoo, Oita (JP)

(73) Assignee: Honda Motor Co., Ltd., Tokyo (JP)

(21) Appl. No.: 17/214,949

(22) Filed: Mar. 29, 2021

(30) Foreign Application Priority Data
Mar. 30, 2020 (JP) 2020-060483

(51) Int. Cl. G10L 15/22; G10L 15/20

(52) U.S. Cl. CPC G10L 15/222; G10L 15/20; G10L 2015/223; G10L 2015/225; G10L 2015/227

(57) ABSTRACT

Provided are a meeting support system, a meeting support method, and a program. The meeting support system includes a meeting support device used by a first participant and a terminal used by a second participant. The meeting support device includes an acquisition unit acquiring utterance information of the first participant, a display unit displaying at least the utterance information of the first participant, and a processing unit determining whether an utterance of the first participant is interrupted when acquiring a wait request from the terminal and changing display of the display unit according to the wait request when it is determined that the utterance of the first participant is interrupted.

### CROSS-REFERENCE TO RELATED APPLICATION

This application claims the priority benefit of Japanese application no. 2020-060483, filed on Mar. 30, 2020. The entirety of the above-mentioned patent application is hereby incorporated by reference herein and made a part of this specification.

### BACKGROUND

### Technical Field

The disclosure relates to a meeting support system, a meeting support method, and a program.

### Description of Related Art

Conventionally, to provide a speech-impaired or hearing-impaired person with support for comprehension at a meeting and the like, a meeting support system which converts uttered voice into text by a voice recognition device and displays the text on a screen has been proposed (for example, refer to Patent Document 1).

In such a system using voice recognition, recognition text gathering each voice input is displayed on a monitor or a terminal. By reading this text, the hearing-impaired person is able to understand the utterances of the meeting participants. Moreover, the displayed text is flowing on the screen as new text is added, and old text may move out of the display range of the screen and may become invisible.

### Patent Document

[Patent Document 1] Japanese Unexamined Patent Application Publication No. 2018-170743

In a conventional system, a participant may not be able to understand the text as soon as he/she reads it, and there is a problem that the text cannot be read when it flows away, and when the participant follows the text, he/she cannot confirm the current utterance.

In addition, at a meeting, a hearing-impaired or speech-impaired person has to input text to a terminal when asking a question about others' utterances, and accordingly, he/she also wishes that others could wait to make utterances. However, the hearing-impaired or speech-impaired person may also be reluctant to interrupt the other participants' utterances to confirm or input text.

### SUMMARY

According to an embodiment of the disclosure, a meeting support system is provided including a meeting support device used by a first participant and a terminal used by a second participant. The meeting support device includes an acquisition unit acquiring utterance information of the first participant, a display unit displaying at least the utterance information of the first participant, and a processing unit, when receiving a wait request from the terminal, determining whether an utterance of the first participant is interrupted, and changing display of the display unit according to the wait request when it is determined that the utterance of the first participant is interrupted.

According to an embodiment of the disclosure, a meeting support method is provided for a meeting support system including a meeting support device used by a first participant and a terminal used by a second participant. The meeting support method includes the following. Utterance information of the first participant is acquired by an acquisition unit of the meeting support device. At least the utterance information of the first participant is displayed by a display unit of the meeting support device. Whether an utterance of the first participant is interrupted is determined by a processing unit of the meeting support device when receiving a wait request from the terminal. Display of the display unit is changed by the processing unit of the meeting support device according to the wait request when it is determined that the utterance of the first participant is interrupted.

According to an embodiment of the disclosure, a non-transitory computer-readable medium is provided storing a program for a computer of a meeting support device in a meeting support system. The meeting support system includes the meeting support device and a terminal. The meeting support device has a display unit and is used by a first participant. The program causes the computer to acquire utterance information of the first participant, to display at least the utterance information of the first participant, to determine whether an utterance of the first participant is interrupted when receiving a wait request from the terminal, and to change display of the display unit according to the wait request when it is determined that the utterance of the first participant is interrupted.

### BRIEF DESCRIPTION OF THE DRAWINGS

FIG. 1 is a block diagram showing a configuration example of a meeting support system according to an embodiment.

FIG. 2 is a diagram showing an example of a meeting according to an embodiment.

FIG. 3 is a diagram showing an example of information displayed on a display unit of a terminal according to an embodiment.

FIG. 4 is a diagram showing an example of information displayed on a display unit of a meeting support device according to an embodiment.

FIG. 5 is a diagram showing an example of information displayed on a display unit of a meeting support device when a wait request is received according to an embodiment.

FIG. 6 is a sequence diagram showing an example of a processing procedure of a meeting support system according to an embodiment.

FIG. 7 is a flowchart of a processing of a meeting support system at the time of a wait request and a cancel request according to an embodiment.

FIG. 8 is an example of a meeting minutes stored by a meeting minutes and voice log storage unit according to an embodiment.

### DESCRIPTION OF THE EMBODIMENTS

The disclosure provides a meeting support system, a meeting support method, and a program which provide a hearing-impaired or speech-impaired person with support for comprehension at a meeting and the like.

(1) A meeting support system according to an embodiment of the disclosure is a meeting support system including a meeting support device used by a first participant and a terminal used by a second participant. The meeting support device includes an acquisition unit acquiring utterance information of the first participant, a display unit displaying at least the utterance information of the first participant, and a processing unit, when receiving a wait request from the terminal, determining whether an utterance of the first participant is interrupted, and changing display of the display unit according to the wait request when it is determined that the utterance of the first participant is interrupted.

(2) In addition, in the meeting support system according to an embodiment of the disclosure, the acquisition unit may be a sound collection unit collecting the utterance of the first participant, the meeting support system may further include a voice recognition unit performing voice recognition processing on the utterance information of the first participant that was collected, and the processing unit may determine whether the utterance of the first participant is interrupted based on a result of the voice recognition processing performed by the voice recognition unit on the utterance information of the first participant.

(3) In addition, in the meeting support system according to an embodiment of the disclosure, the processing unit of the meeting support device may associate a fact that the wait request was made for a previous utterance with a meeting minutes when the utterance of the first participant is ongoing at a time of receipt of the wait request, and may associate a fact that the wait request was made for a latest utterance with the meeting minutes when the utterance of the first participant is not ongoing at the time of receipt of the wait request.

(4) In addition, in the meeting support system according to an embodiment of the disclosure, the terminal may include an operation unit transmitting the wait request to the meeting support device.

(5) A meeting support method according to an embodiment of the disclosure is a meeting support method for a meeting support system including a meeting support device used by a first participant and a terminal used by a second participant. The meeting support method includes: acquiring utterance information of the first participant by an acquisition unit of the meeting support device; displaying at least the utterance information of the first participant by a display unit of the meeting support device; and determining whether an utterance of the first participant is interrupted by a processing unit of the meeting support device when receiving a wait request from the terminal, and changing display of the display unit by the processing unit of the meeting support device according to the wait request when it is determined that the utterance of the first participant is interrupted.

(6) A program according to an embodiment of the disclosure is for a computer of a meeting support device in a meeting support system, the meeting support system including the meeting support device and a terminal, the meeting support device having a display unit and being used by a first participant and the terminal being used by a second participant. The program causes the computer to acquire utterance information of the first participant, to display at least the utterance information of the first participant, to determine whether an utterance of the first participant is interrupted when receiving a wait request from the terminal, and to change display of the display unit according to the wait request when it is determined that the utterance of the first participant is interrupted.

According to (1) to (6), since the uttered content can be confirmed by making a process wait for a while, it is possible to provide a hearing-impaired or speech-impaired person with support for comprehension at a meeting and the like. In addition, according to (1) to (6), since there is a time lag from when the wait request is transmitted until when the utterance actually stops, time can be gained for the speech-impaired or hearing-impaired person for inputting an utterance.

According to (2), since the wait request is displayed to a speaker at the timing when their utterance is interrupted, the speaker's utterance is not disturbed, and psychological burden of stopping the utterance can be reduced.

According to (3), it is known that the utterance corresponding to the wait request takes time to be understood by the speech-impaired or hearing-impaired person, and this may serve as a useful reference for how to proceed with the next and subsequent meetings.

According to (4), the speech-impaired or hearing-impaired person is able to notify a meeting participant of the wait request simply by pressing a wait button without operating the terminal and inputting text of the wait request.

Hereinafter, embodiments of the disclosure will be described with reference to the drawings.

First, an example of a situation in which a meeting support system of the present embodiment is used will be described.

The meeting support system of the present embodiment is used at a meeting participated by two or more persons. Among the participants, there may be a speech-impaired or hearing-impaired person who has difficulty speaking. A participant able to speak makes an utterance using a microphone. In addition, the speech-impaired or hearing-impaired person holds a terminal (such as a smartphone, a tablet terminal, or a personal computer). The meeting support system displays text on a display unit of a meeting support device and on the terminal of the speech-impaired or hearing-impaired person, in which the text is generated by voice recognition and textualization performed on a voice signal uttered by the participant, or input by the speech-impaired or hearing-impaired person by operating the terminal device.

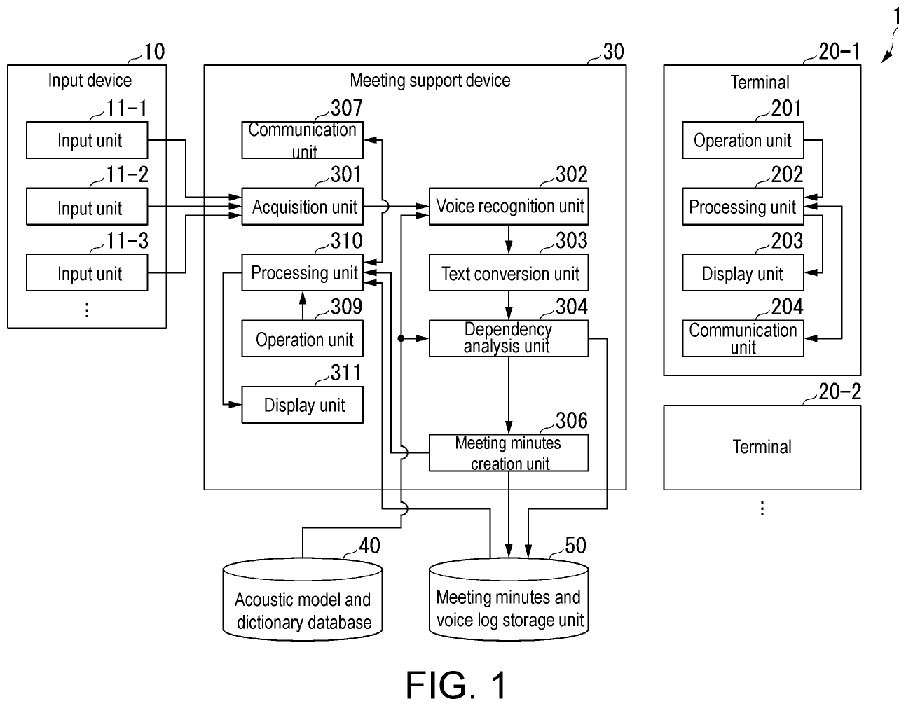

FIG. 1 is a block diagram showing a configuration example of a meeting support system 1 according to the present embodiment.

First, a configuration of the meeting support system 1 will be described.

As shown in FIG. 1, the meeting support system 1 includes an input device 10, a terminal 20-1, a terminal 20-2, and so on, a meeting support device 30, an acoustic model and dictionary database 40, and a meeting minutes and voice log storage unit 50. When not referring to a specific one of the terminal device 20-1 and the terminal device 20-2, the term “terminal 20” is used.

The input device 10 includes an input unit 11-1, an input unit 11-2, an input unit 11-3, and so on. When not referring to a specific one of the input unit 11-1, the input unit 11-2, the input unit 11-3, and so on, the term “input unit 11” is used.

The terminal 20 includes an operation unit 201, a processing unit 202, a display unit 203, and a communication unit 204.

The meeting support device 30 includes an acquisition unit 301, a voice recognition unit 302, a text conversion unit 303, a dependency analysis unit 304, a meeting minutes creation unit 306, a communication unit 307, an operation unit 309, a processing unit 310, and a display unit 311.

The input device 10 and the meeting support device 30 are connected by wire or wirelessly. The terminal 20 and the meeting support device 30 are connected by wire or wirelessly.

First, the input device 10 will be described.

The input device 10 outputs a voice signal uttered by a user to the meeting support device 30. Moreover, the input device 10 may be a microphone array. In this case, the input device 10 includes P microphones arranged at different positions. The input device 10 generates acoustic signals of P channels (P is an integer of 2 or more) from the sound collected, and outputs the generated voice signals of P channels to the meeting support device 30.

The input unit 11 is a microphone. The input unit 11 collects the voice signal of the user, converts the collected voice signal from analog into digital, and outputs the voice signal converted into the digital signal to the meeting support device 30. Moreover, the input unit 11 may output a voice signal in the analog form to the meeting support device 30. The input unit 11 may output the voice signal to the meeting support device 30 by wire such as via a cord or cable, or may transmit the voice signal to the meeting support device 30 wirelessly. The input unit 11 may also include a switch which switches between an on-state and an off-state. In this case, a speaker may switch the input unit 11 to the on-state at the start of an utterance and switch it to the off-state at the end of the utterance. Furthermore, in this case, the voice signal output to the meeting support device 30 may include information indicating the start of the utterance and information indicating the end of the utterance.

Next, the terminal 20 will be described.

The terminal 20 is, for example, a smartphone, a tablet terminal, a personal computer, or the like. The terminal 20 may include a voice output unit, a motion sensor, a global positioning system (GPS), and the like.

The operation unit 201 detects an operation of the user and outputs a detected result to the processing unit 202. The operation unit 201 is, for example, a touch panel sensor provided on the display unit 203, or a keyboard.

The processing unit 202 generates transmission information according to an operation result output by the operation unit 201, and outputs the generated transmission information to the communication unit 204. The transmission information includes a wait request requesting a meeting to stop proceeding and wait, or a cancel request requesting cancellation of a wait state. Moreover, the transmission information may include identification information of the terminal 20.

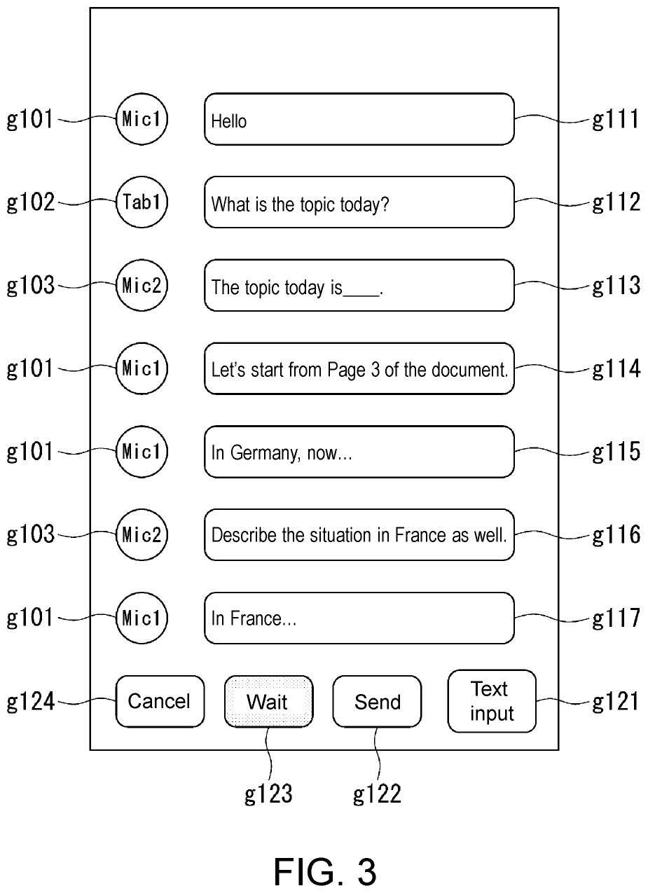

The processing unit 202 acquires text information output by the communication unit 204, converts the acquired text information into image data, and outputs the image data obtained by conversion to the display unit 203. The processing unit 202 outputs the input text information to the communication unit 204 based on an operation result of the operation unit 201. Moreover, the text information includes the identification information of the terminal 20. The processing unit 202 converts the input text information into image data based on the operation result of the operation unit 201, and outputs the image data obtained by conversion to the display unit 203. Moreover, an image displayed on the display unit 203 will be described later with reference to FIG. 3.

The display unit 203 is, for example, a liquid crystal display device, an organic electroluminescence (EL) display device, an electronic ink display device, or the like. The display unit 203 displays the image data output by the processing unit 202.

The communication unit 204 receives text information or meeting minutes information from the meeting support device 30, and outputs the received information to the processing unit 202. The communication unit 204 transmits the wait request or the cancel request output by the processing unit 202 to the meeting support device 30. The communication unit 204 transmits the text information output by the processing unit 202 to the meeting support device 30.

Next, the acoustic model and dictionary database 40 will be described.

The acoustic model and dictionary database 40 stores, for example, an acoustic model, a language model, a word dictionary, and the like. The acoustic model is a model based on sound features, and the language model is a model of information on words and their arrangements. The word dictionary is a dictionary including a large number of vocabularies, and is for example, a large vocabulary word dictionary.

Next, the meeting minutes and voice log storage unit 50 will be described.

The meeting minutes and voice log storage unit 50 stores a meeting minutes (included in a voice signal). Moreover, the meeting minutes and voice log storage unit 50 may store the meeting minutes in association with the information indicating that a wait request was made and information indicating at which timing the wait request was made.

Next, the meeting support device 30 will be described.

The meeting support device 30 is, for example, any one of a personal computer, a server, a smartphone, a tablet terminal, or the like. Moreover, in the case that the input device 10 is a microphone array, the meeting support device 30 further includes a sound source localization unit, a sound source separation unit, and a sound source identification unit. The meeting support device 30 performs voice recognition and textualization on the voice signal uttered by the participant for, for example, each utterance. Then, the meeting support device 30 displays the text information of the textualized utterance content on the display unit 311 and transmits it to the terminal 20 of the participant. When a wait request is received from the terminal 20, the meeting support device 30 transmits the text information of the utterance content to the terminal 20 of each participant at the time when an ongoing utterance ends. When the wait request is received from the terminal 20, the meeting support device 30 detects that an ongoing utterance has ended, displays the text information of the utterance content on the display unit 311 at the time when the utterance ends, and then changes the display of the display unit 311 based on the wait request. In addition, the meeting support device 30 stores the input unit 11 and the terminal 20 that are used at the meeting.

The acquisition unit 301 acquires the voice signal output by the input unit 11, and outputs the acquired voice signal to the voice recognition unit 302. In the case that the acquired voice signal is an analog signal, the acquisition unit 301 converts the analog signal into a digital signal, and outputs the voice signal converted into the digital signal to the voice recognition unit 302. Moreover, the voice signal includes the identification information (for example, Mic 1, Mic 3, etc.) of the used input unit 11.

In the case that there are multiple input units 11, the voice recognition unit 302 performs voice recognition for each speaker using the input units 11.

The voice recognition unit 302 acquires the voice signal output by the acquisition unit 301. The voice recognition unit 302 detects, from the voice signal output by the acquisition unit 301, a voice signal of an utterance section. The detection of the utterance section is, for example, detection of a voice signal of a predetermined threshold value or higher as an utterance section. Moreover, the voice recognition unit 302 may perform the detection of utterance section using other well-known methods. The voice recognition unit 302 performs voice recognition on the detected voice signal of the utterance section using a well-known method with reference to the acoustic model and dictionary database 40. Moreover, the voice recognition unit 302 performs voice recognition using, for example, a method disclosed in Japanese Unexamined Patent Application Publication No. 2015-64554. The voice recognition unit 302 includes the identification information of the input unit 11 in a recognition result and the voice signal, and outputs them to the text conversion unit 303. Moreover, the voice recognition unit 302 associates the recognition result with the voice signal and outputs them for, for example, each sentence, or each utterance section, or each speaker.

The text conversion unit 303 performs text conversion based on the recognition result output by the voice recognition unit 302. The text conversion unit 303 includes the identification information of the input unit 11 in the text information obtained by conversion and the voice signal, and outputs them to the dependency analysis unit 304. Moreover, the text conversion unit 303 may delete interjections such as “ah”, “uh”, “eh”, and “well” to perform the text conversion.

The dependency analysis unit 304 performs morphological analysis and dependency analysis on the text information output by the text conversion unit 303. The dependency analysis, for example, uses a support vector machine (SVM) in a shift-reduce method, a spanning tree method, or a cascaded chunk identification method. The dependency analysis unit 304 includes the identification information of the input unit 11 in the text information as a result of the dependency analysis and the voice signal, and outputs them to the meeting minutes creation unit 306.

The meeting minutes creation unit 306 creates a meeting minutes for each speaker separately based on the text information and voice signal output by the dependency analysis unit 304. The meeting minutes creation unit 306 creates text information for each input unit 11 based on the text information output by the dependency analysis unit 304 and the identification information of the input unit 11. The meeting minutes creation unit 306 outputs the text information created for each input unit 11 to the processing unit 310. The meeting minutes creation unit 306 stores the created meeting minutes and its corresponding voice signal in the meeting minutes and voice log storage unit 50. Moreover, the meeting minutes creation unit 306 may delete interjections such as “ah”, “uh”, “eh”, and “well” to create the meeting minutes.

The communication unit 307 transmits information to and receives information from the terminal 20. The information received from the terminal 20 includes wait requests, cancel requests, text information, transmission requests for transmission of past meeting minutes, and the like. Moreover, the text information and the transmission request for transmission of past meeting minutes include identification information for identifying the terminal 20 that transmitted the transmission request. The information transmitted to the terminal 20 includes text information, information of past meeting minutes, and the like. The communication unit 307 outputs the information received from the terminal 20 to the processing unit 310. The communication unit 307 transmits the text information output by the processing unit 310, the information of past meeting minutes, and the like to the terminal 20.

The operation unit 309 is, for example, a keyboard, a mouse, or a touch panel sensor provided on the display unit 311. The operation unit 309 detects an operation result of the user and outputs the detected operation result to the processing unit 310.

The processing unit 310 causes the text information of each input unit 11 created by the meeting minutes creation unit 306 to be displayed on the display unit 311, and outputs the text information to the communication unit 307. The processing unit 310 causes the acquired text information to be displayed on the display unit 311. The processing unit 310 acquires the wait requests, cancel requests, text information, and transmission requests for information of past meeting minutes output by the communication unit 307. When a wait request is acquired, the processing unit 310 detects that an ongoing utterance has ended, causes the text information of the utterance content to be displayed on the display unit 311 at the time when the utterance ends, and then changes the display of the display unit 311 based on the wait request. Moreover, an example of changing the display will be described later. When a cancel request is acquired, the processing unit 310 restores the display that was changed according to the wait request to its original state. When a transmission request for the information of past meeting minutes is acquired, the processing unit 310 reads the information of past meeting minutes from the meeting minutes and voice log storage unit 50, and outputs the read information of past meeting minutes to the communication unit 307.

The display unit 311 is, for example, a liquid crystal display device, an organic EL display device, an electronic ink display device, or the like. The display unit 311 displays the text information output by the processing unit 310. The display unit 311 changes the display according to the processing of the processing unit 310.

Moreover, in the case that the input device 10 is a microphone array, the meeting support device 30 further includes a sound source localization unit, a sound source separation unit, and a sound source identification unit. In this case, in the meeting support device 30, with respect to the voice signal acquired by the acquisition unit 301, the sound source localization unit performs sound source localization using a pre-generated transfer function. Then, in the meeting support device 30, speaker identification is performed using a result of the localization by the sound source localization unit. In the meeting support device 30, sound separation is performed on the voice signal acquired by the acquisition unit 301 using the result of the localization by the sound source localization unit. Then, the voice recognition unit 302 of the meeting support device 30 performs utterance section detection and voice recognition on the separated voice signal (for example, refer to Japanese Unexamined Patent Application Publication No. 2017-9657). In addition, the meeting support device 30 may perform reverberation suppression processing.

Example of Method of Detecting End of Utterance

Next, a method of detecting an end of an utterance will be described.

The processing unit 310 of the meeting support device 30 may identify an end of an utterance for each speaker based on, for example, information on the start and end of an utterance included in the voice signal. In this case, for example, a time when the input unit 11 changes to the on-state may be set as a start of an utterance, and a time when the input unit 11 changes to the off-state may be set as an end of the utterance.

Alternatively, it may be determined that an utterance has ended when the processing unit 310 detects the voice signal of the input unit 11 and no utterance has occurred for a predetermined period of time or more (equal to or lower than a predetermined value).

Example of Meeting

Here, an example of a meeting in the following description will be described.

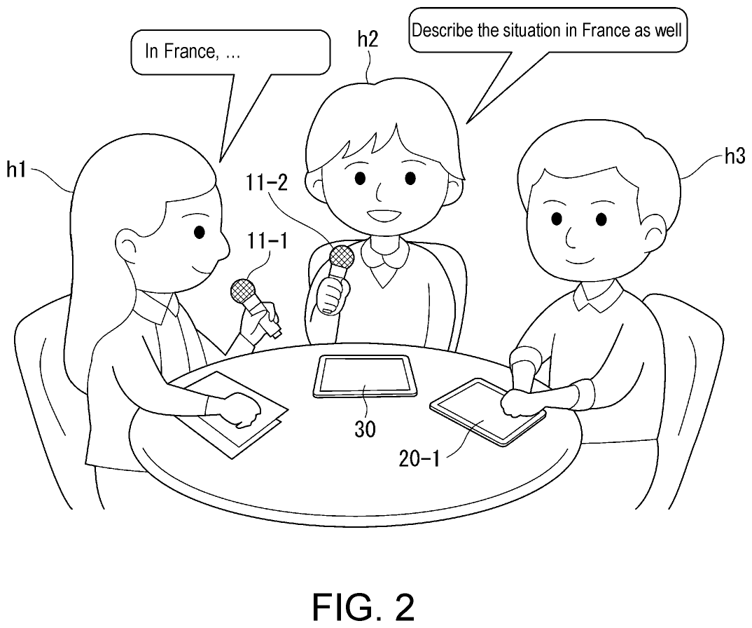

FIG. 2 is a diagram showing an example of a meeting according to the present embodiment. In the example shown in FIG. 2, there are three participants (a first participant h1, a second participant h2, and a third participant h3) at a meeting. Here, it is assumed that the second participant h2 is a hearing-impaired person who is able to speak and the third participant h3 is a hearing-impaired person who has difficulty speaking. The first participant h1 makes an utterance using the input unit 11-1 (microphone). The second participant h2 makes an utterance using the input unit 11-2. The first participant h1 and the second participant h2 look at the display unit 311 of the meeting support device 30. The third participant h3 uses the terminal 20-1.

The first participant h1 and the second participant h2 can respectively confirm the text information input by the third participant h3 by looking at the textualized utterance content displayed on the meeting support device 30. The third participant h3 can confirm the utterance content uttered by the first participant h1 and the second participant h2 as text information by looking at the text information displayed on the terminal 20-1. When the third participant h3 becomes unable to follow the utterance content displayed on the terminal 20-1, the third participant h3 operates the operation unit 201 and selects a wait option. As a result, the display of the display unit 311 of the meeting support device 30 changes, the first participant h1 and the second participant h2 can understand that the third participant h3 wants them to wait for him/her to understand the content of the meeting, and they will not start their next utterance. During this time, the third participant h3 reads the display on the terminal 20-1, and when finishing reading, operates the operation unit 201 and selects a cancel option. According to the cancel request received from the terminal 20-1, the meeting support device 30 restores the display to its original state. As a result, the first participant h1 and the second participant h2 can continue the meeting after having confirmed that the third participant h3 has understood the content of the meeting. Moreover, the meeting may be a TV meeting.

Example of Display on Terminal

Next, an example of information displayed on the display unit 203 of the terminal 20 will be described.

FIG. 3 is a diagram showing an example of the information displayed on the display unit 203 of the terminal 20 according to the present embodiment.

Circles g101 to g103 on the left represent the input unit 11 (microphone) or the terminal 20 where an utterance or a text input is performed. The circle g101 indicates that an utterance is made via the input unit 11-1 (Mic 1), the circle g102 indicates that an input is made via the terminal 20-1 (Tab 1), and the circle g103 indicates that an utterance is made via the input unit 11-2 (Mic 2).

Text images gill to g117 show the text information as a result of voice recognition on an uttered voice signal, or the text information input via the terminal 20-1. The text images g111, g114, g115, and g117 show the text information uttered via the input unit 11-1 (Mic 1), the text image g112 shows the text information input via the terminal 20-1 (Tab1), and the text images g113 and g116 show the text information uttered via the input unit 11-2 (Mic 2).

Button images g121 to g124 are images of buttons. The button image g121 is selected when the user is inputting text, and the button image g122 is selected when transmitting the input text image to the meeting support device 30. The button image g123 is selected when it is desired that the meeting stop proceeding and wait, and the button image g124 is selected when cancelling the request for requesting the meeting to stop proceeding and wait. The button images g123 and g124 may be of a toggle type, or may be configured so that the display of the button image g123 is changed to the display of the button image g124 when the button image g123 is selected.

Example of Display of Meeting Support Device

Next, an example of the information displayed on the display unit 311 of the meeting support device 30 will be described.

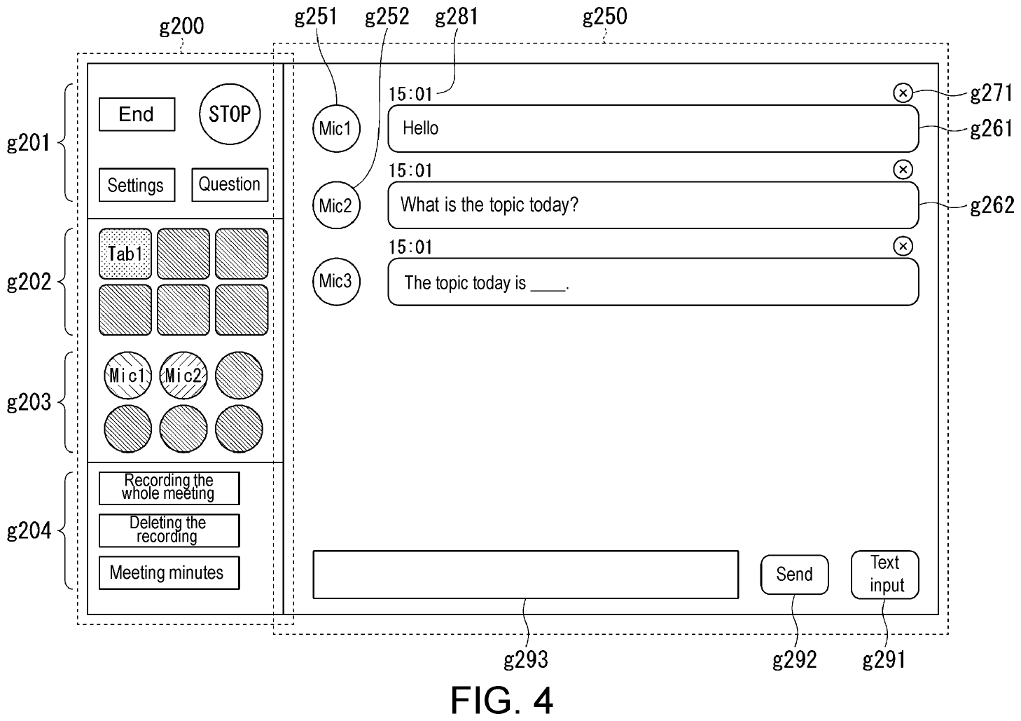

FIG. 4 is a diagram showing an example of the information displayed on the display unit 311 of the meeting support device 30 according to the present embodiment. Moreover, the display in FIG. 4 is displayed in a state in which no wait request is received from the terminal 20 or when a cancel request is received.

In FIG. 4, an area g200 on the left side of the display unit 311 is an area in which button images for setting are displayed. An area g250 on the right side of the display unit 311 is an area in which text information and the like are displayed.

An area g201 is an area in which button images for setting a start and an end of use of the meeting support device 30 are displayed.

An area g202 is an area in which button images for setting the terminal 20 to be used are displayed.

An area g203 is an area in which button images for setting the input unit 11 to be used are displayed.

An area g204 is an area in which button images for setting, such as recording of an utterance during a meeting, deletion of the recording, reference to past meeting minutes and the like, are displayed.

Circles g251 to g252 represent the input unit 11 (microphone) or the terminal 20 where an utterance or a text input is performed. The circle g251 indicates that an utterance is made via the input unit 11-1 (Mic 1), and the circle g252 indicates that an utterance is made via the input unit 11-2 (Mic 2).

Text images g261 to g262 show the text information as a result of voice recognition of the uttered voice signal, or the text information input via the terminal 20-1. The text image g261 shows the text information uttered via the input unit 11-1 (Mic 1), and the text image g262 shows the text information uttered via the input unit 11-2 (Mic 2).

A button image g271 represents a button image to be selected when deleting the uttered or input text information. An image g281 shows a time at which the text information is uttered or input.

Button images g291 to g292 are images of buttons. The button image g291 is selected when the user is inputting text, and the button image g292 is selected when transmitting the input text image to the terminal 20.

A text input field image g293 represents a field in which the input text information is displayed when the user is inputting text.

Next, in the case where a “wait” button image was selected via the terminal 20 and the meeting support device 30 has received a wait request, an example of the information displayed when an utterance that was ongoing at the time of receipt of the wait request ends will be described.

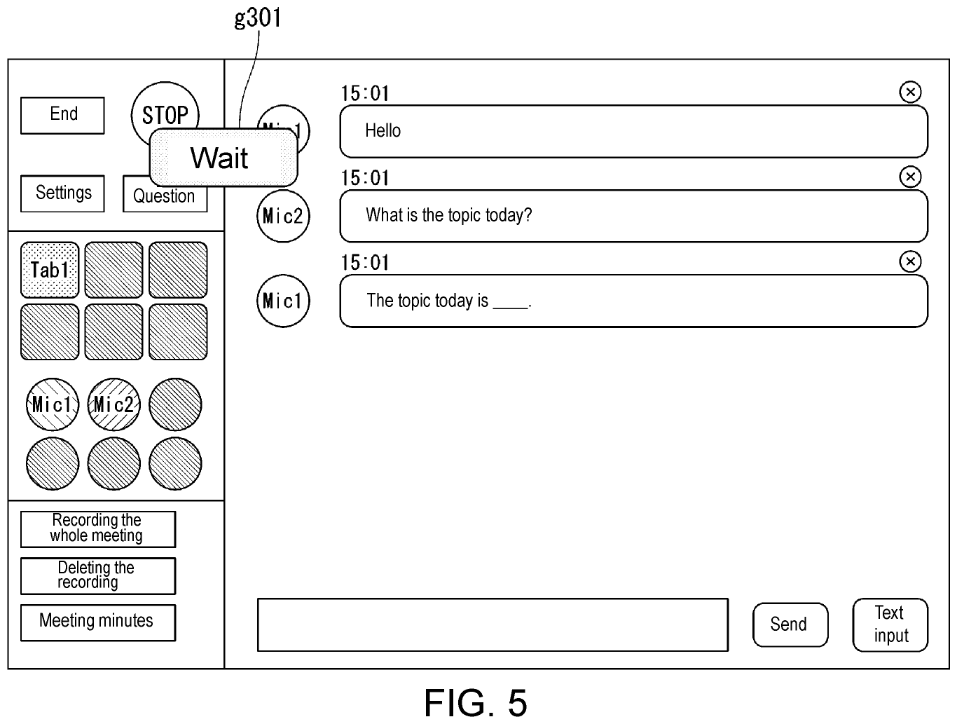

FIG. 5 is a diagram showing an example of the information displayed on the display unit 311 of the meeting support device 30 when a wait request is received according to the present embodiment. As shown in FIG. 5, on the display unit 311 of the meeting support device 30, a wait image g301 (for example, showing the text “wait”) indicating a wait request is displayed when an utterance that was ongoing at the time of receipt of the wait request ends. The position of the display is not limited to the position shown in FIG. 5 and may be any position on the display unit 311.

Moreover, the example of a screen changing at the time of a wait request shown in FIG. 5 is one example, and the disclosure is not limited thereto. For example, after having received the wait request, when an utterance that was ongoing at the time of receipt of the wait request ends, the meeting support device 30 may, for instance, change the color of the entire screen or the background or the like, or display a vibrating screen.

Example of Processing Procedure of Meeting Support System

Next, a processing procedure of a meeting support system will be described.

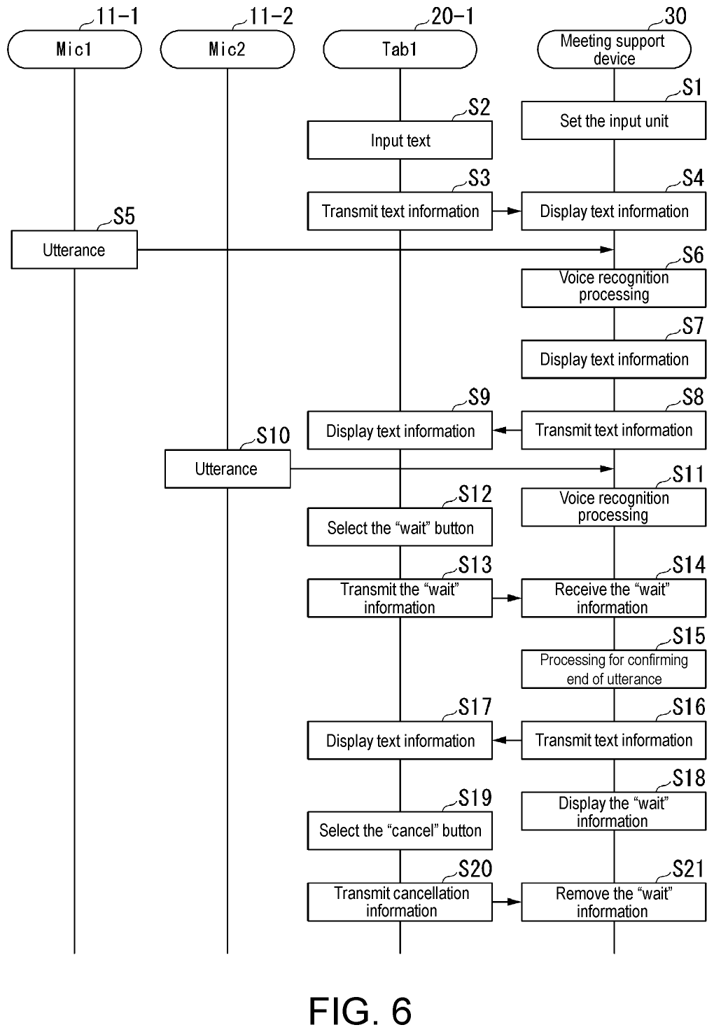

FIG. 6 is a sequence diagram showing an example of a processing procedure of the meeting support system 1 according to the present embodiment. In the example of FIG. 6, there are three participants at the meeting, in which two of them use the input unit 11, and one uses the terminal 20-1.

(Step S1) The processing unit 310 of the meeting support device 30 sets the input unit 11 to be used, based on an operation result of the user operating the operation unit 309. In this example, the input unit 11-1 (Mic 1) and the input unit 11-2 (Mic 2) are to be used.

(Step S2) The processing unit 202 of the terminal 20-1 acquires the input text information based on an operation result of the user operating the operation unit 201. Then, the processing unit 202 causes the input text information to be displayed on the display unit 203.

(Step S3) The processing unit 202 of the terminal 20-1 transmits the input text information to the meeting support device 30 based on the operation result of the user operating the operation unit 201.

(Step S4) The processing unit 310 of the meeting support device 30 causes the received text information to be displayed on the display unit 311.

(Step S5) The input unit 11-1 outputs a voice signal collecting an utterance of a participant to the meeting support device 30.

(Step S6) The meeting support device 30 performs voice recognition processing and dependency processing on the acquired voice signal.

(Step S7) The processing unit 310 of the meeting support device 30 causes the text information on which the voice recognition processing and the like were performed to be displayed on the display unit 311.

(Step S8) The processing unit 310 of the meeting support device 30 transmits the text information on which the voice recognition processing and the like were performed to the terminal 20-1 via the communication unit 307.

(Step S9) The processing unit 202 of the terminal 20-1 causes the received text information to be displayed on the display unit 203.

(Step S10) The input unit 11-2 outputs the voice signal collecting the utterance of the participant to the meeting support device 30.

(Step S11) The meeting support device 30 performs voice recognition processing, dependency processing, and the like on the acquired voice signal.

(Step S12) The processing unit 202 of the terminal 20-1 detects that a “wait” button image was selected based on the operation result of the user operating the operation unit 201.

(Step S13) The processing unit 202 of the terminal 20-1 transmits to the meeting support device 30 a wait request indicating that the “wait” button image was selected.

(Step S14) The processing unit 310 of the meeting support device 30 receives via the communication unit 307 the wait request indicating that the “wait” button image was selected.

(Step S15) When the wait request is received, the processing unit 310 of the meeting support device 30 confirms whether the utterance in step S14 is ongoing or has finished.

(Step S16) When it can be confirmed that the utterance has finished, the processing unit 310 of the meeting support device 30 transmits the text information recognized by the voice recognition processing and the like to the terminal 20-1.

(Step S17) The processing unit 202 of the terminal 20-1 causes the received text information to be displayed on the display unit 203.

(Step S18) When it can be confirmed that the utterance has finished, the processing unit 310 of the meeting support device 30 changes the display on the display unit 311 to, for example, a “wait” image, based on the received wait request.

(Step S19) The processing unit 202 of the terminal 20-1 detects that a “cancel” button image was selected based on the operation result of the user operating the operation unit 201.

(Step S20) The processing unit 202 of the terminal 20-1 transmits to the meeting support device 30 a cancel request indicating that the “cancel” button image was selected.

(Step S21) The processing unit 310 of the meeting support device 30 receives via the communication unit 307 the cancel request indicating that the “cancel” button image was selected. Then, the processing unit 310 removes the “wait” displayed in step S18 or the like, and restores the changed display of the display unit 311 to its original state.

Moreover, the processing procedure shown in FIG. 6 is one example, and the processing of steps S16 and S18 may be performed at the same time, or the processing order may be reversed.

Example of Processing Procedure at Time of Wait Request and Cancel Request

Next, a processing procedure of a meeting support system at the time of a wait request and a cancel request will be described.

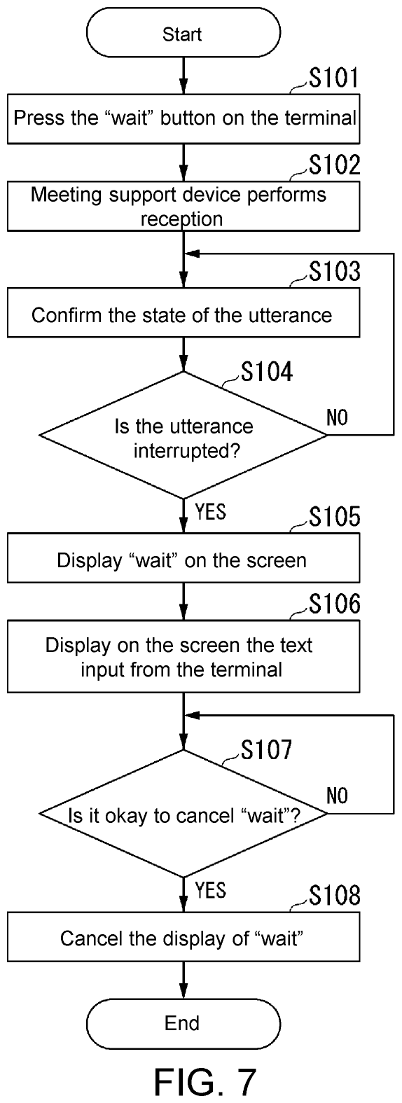

FIG. 7 is a flowchart of a processing of the meeting support system 1 at the time of a wait request and a cancel request according to the present embodiment.

(Step S101) The user operates the operation unit 201 of the terminal 20 and presses the “wait” button. Then, the processing unit 202 of the terminal 20 detects that the “wait” button image was selected based on the operation result of the user operating the operation unit 201.

Then, the processing unit 202 transmits to the meeting support device 30 a wait request indicating that the “wait” button image was selected. In addition, the processing unit 202 notifies the user that the selection of the “wait” button is received, for example, by changing the display (such as by changing the color, brightness, etc.) of the button image g123 (see FIG. 3) corresponding to the “wait” button displayed on the display unit 203.

(Step S102) The processing unit 310 of the meeting support device 30 receives via the communication unit 307 the wait request indicating that the “wait” button image was selected.

(Step S103) When the wait request is received, the processing unit 310 of the meeting support device 30 confirms whether the utterance is interrupted, that is, whether the utterance is ongoing or has finished.

(Step S104) In the case that the processing unit 310 of the meeting support device 30 identifies that the utterance is interrupted (the utterance has finished) (step S104; YES), the process proceeds to step S105. In the case that the processing unit 310 of the meeting support device 30 identifies that the utterance is not interrupted (the utterance is ongoing) (step S104; NO), the process returns to step S103.

(Step S105) The processing unit 310 of the meeting support device 30 changes the display on the display unit 311 to, for example, a “wait” image based on the received wait request.

(Step S106) When the text information is input via the terminal 20-1 during the display of “wait”, the processing unit 310 of the meeting support device 30 causes the text information received from the terminal 20 to be displayed on the display unit 311 while “wait” remains displayed.

(Step S107) The processing unit 310 of the meeting support device 30 determines whether the display of “wait” may be canceled, by identifying whether a cancel request indicating that the “cancel” button image was selected is received via the communication unit 307. In the case that the processing unit 310 determines that the display of “wait” may be canceled (step S107; YES), the process proceeds to step S108. In the case that the processing unit 310 determines that the display of “wait” should not be canceled (step S107; NO), the processing unit 310 repeats the processing of step S107.

(Step S108) The processing unit 310 of the meeting support device 30 removes the “wait” and the like, and restores the changed display of the display unit 311 to its original state.

Moreover, in the above-mentioned example, an example that each speaker makes an utterance using a different input unit 11 has been described. However, the disclosure is not limited thereto. There may be one input unit 11. In this case, multiple participants use one input unit 11. In this case, the meeting support device 30 may, for example, register each participant's voice in advance, and recognize a speaker by voice recognition so as to display it on the display unit 311 of the meeting support device 30 and on the display unit 203 of the terminal 20. Alternatively, the meeting support device 30 may cause a number (such as Mic 1 or Mic 2) of the microphone corresponding to the input unit 11 that is used to be displayed on the display unit 311 of the meeting support device 30 and on the display unit 203 of the terminal 20, regardless of the speaker.

Moreover, the timing for the speech-impaired or hearing-impaired person to select (press) the “wait” button corresponding to the wait request is not limited to the time when the content takes time to understand and he/she wants the meeting to stop for a while. Since text information is input by operating the operation unit 201 of the terminal 20, the input may take time. As the speaker continues, it becomes difficult for a physically unimpaired participant to recognize which topic is asked about. Furthermore, sometimes the speech-impaired or hearing-impaired person may become unable to keep up with the content when an utterance is made during their input and the utterances increase. Therefore, when the speech-impaired or hearing-impaired person, for example, wants to make an utterance such as by inputting a question or the like, he/she may select the “wait” button corresponding to the wait request.

Here, an example of a meeting minutes will be described.

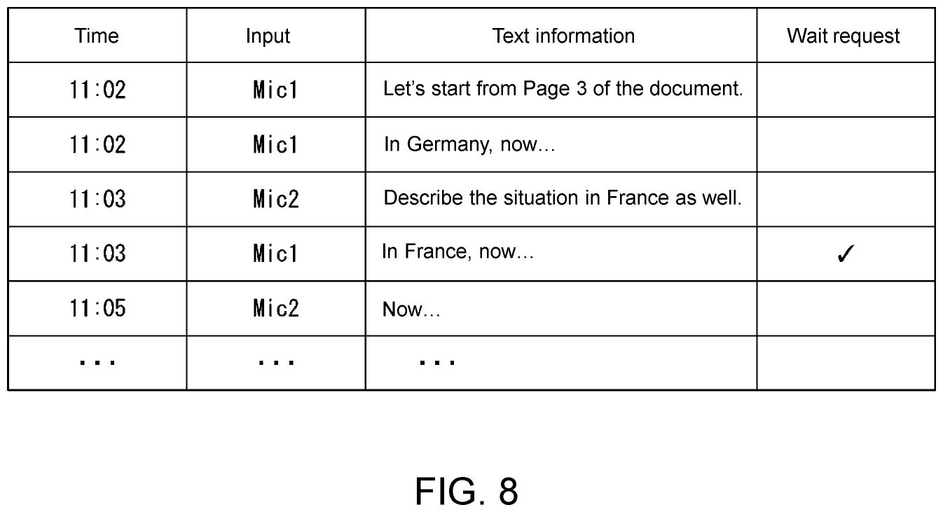

FIG. 8 is an example of a meeting minutes stored by the meeting minutes and voice log storage unit 50 according to the present embodiment.

The processing unit 310 of the meeting support device 30 may control the meeting minutes creation unit 306 to, when a wait request is received, associate a fact that the wait request was made for a previous utterance with a meeting minutes in the case where an utterance is ongoing at the time of receipt of the wait request, and to store the meeting minutes in the meeting minutes and voice log storage unit 50. In the example of FIG. 8, an example is shown in which, before a speech-impaired or hearing-impaired person finishes reading the content of an utterance “In France, now . . . ” made at 11:03, the next utterance “Now . . . ” made at 11:05 has started. In such a case, since the speech-impaired or hearing-impaired person wants the meeting to wait in order to read the content of the utterance “In France, now . . . ,” he/she selects the “wait” button. As a result, the meeting support device 30 stores the fact that there is a wait request in association with the utterance “In France, now . . . ”. Moreover, in the stored meeting minutes, the text information (utterance information) may be associated with information showing the time of the utterance and the input unit 11 or the terminal 20 used for the utterance. Therefore, according to the present embodiment, it is known that such an utterance takes time to be understood by the speech-impaired or hearing-impaired person, and this may serve as a useful reference for how to proceed with the next and subsequent meetings.

In addition, the processing unit 310 may control the meeting minutes creation unit 306 to, when the wait request is received, associate a fact that the wait request was made for a latest utterance with the meeting minutes in the case where no utterance is ongoing at the time of receipt of the wait request, and to store the meeting minutes in the meeting minutes and voice log storage unit 50.

In the present embodiment, the speech-impaired or hearing-impaired person operates the terminal 20 and selects the “wait” button when the content takes time to understand and he/she wants the meeting to stop for a while, or when he/she wants to make an utterance such as by asking a question. When a wait request is received from the terminal 20, the meeting support device 30 confirms that an utterance of the speaker is interrupted or has ended, and may, for example, display “wait” on the display unit 311 that the speaker is looking at when the speaker's utterance is interrupted or ends.

Therefore, according to the present embodiment, since a speech-impaired or hearing-impaired person may simply press the button image corresponding to the “wait” button and does not have to say (by text input) something like “wait a minute”, the disclosure is user-friendly. In addition, according to the present embodiment, since the message “wait” is displayed to a speaker at the timing when their utterance is interrupted, the speaker's utterance is not disturbed, and psychological burden of stopping the utterance can be reduced. Furthermore, according to the present embodiment, since there is a time lag from when the button is pressed until the utterance actually stops, time can be gained for the speech-impaired or hearing-impaired person for inputting an utterance.

Moreover, although the above-mentioned example describes an example having two participants able to speak and one participant having difficulty speaking, there may be one participant able to speak and two hearing-impaired participants who have difficulty speaking. In this case, for example, while one of the hearing-impaired persons who inputs text information quickly is inputting text information (utterance information) using the meeting support device 30 without pressing the “wait” button, the other hearing-impaired person may press the “wait” button. In such a case, the meeting support device 30 may determine whether the input of the text information has ended or is interrupted, and may change the display on the display unit 311 so that the display unit 311 displays “wait” when the input of the text information has ended or is interrupted. In this way, in the meeting support device 30, the utterance caused to wait when the wait request is received is not limited to the utterance made via the input unit 11 (microphone), but may also be an utterance of an extract and information input via a keyboard or the like.

Moreover, a program for realizing all or some of the functions of the meeting support device 30 in the disclosure, or all or some of the functions of the terminal 20 may be recorded on a computer-readable recording medium. By loading the program recorded on this recording medium into a computer system and executing it, all or part of the processing performed by the meeting support device 30, or all or part of the processing performed by the terminal 20 may be performed. The term “computer system” as used herein includes hardware such as an OS, a peripheral device, and the like. Also, the “computer system” includes a WWW system provided with a homepage providing environment (or display environment). In addition, the term “computer-readable recording medium” refers to a portable medium such as a flexible disk, a magneto-optical disk, a ROM, and a CD-ROM, or a storage device such as a hard disk built in a computer system. Furthermore, the term “computer-readable recording medium” also includes something that holds a program for a certain period of time, like a volatile memory (RAM) inside a computer system serving as a server or a client in the case where the program is transmitted via a network such as the Internet or a communication line such as a telephone line.

In addition, the above program may be transmitted from a computer system in which this program is stored in a storage device and the like to another computer system via a transmission medium or a transmission wave in a transmission medium. Here, the “transmission medium” transmitting the program refers to a medium having a function of transmitting information, like a network (communication network) such as the Internet or a communication line such as a telephone line. In addition, the above program may be used for realizing some of the above-mentioned functions. Furthermore, the above program may be a so-called diff file (diff program) which may realize the above-mentioned functions in combination with a program already recorded in the computer system.

The embodiments for carrying out the disclosure have been described above. However, the disclosure is not limited to these embodiments in any way, and various modifications and substitutions may be applied without departing from the gist of the disclosure.

What is claimed is:

1. A meeting support system, comprising:
a meeting support device, used by a first participant; and
a terminal, used by a second participant, wherein
the meeting support device comprises:
an acquisition unit, acquiring utterance information of the first participant;
a display unit, displaying at least the utterance information of the first participant; and
a processing unit, when receiving a wait request from the terminal, determining whether an utterance of the first participant is interrupted, and changing display of the display unit according to the wait request when it is determined that the utterance of the first participant is interrupted.

2. The meeting support system according to claim 1, wherein
the acquisition unit is a sound collection unit collecting the utterance of the first participant;
the meeting support system further comprises a voice recognition unit performing a voice recognition processing on the utterance information of the first participant that was collected;
the processing unit determines whether the utterance of the first participant is interrupted based on a result of the voice recognition processing performed by the voice recognition unit on the utterance information of the first participant.

3. The meeting support system according to claim 1, wherein the processing unit of the meeting support device
associates a fact that the wait request was made for a previous utterance with a meeting minutes when the utterance of the first participant is ongoing at a time of receipt of the wait request, and
associates a fact that the wait request was made for a latest utterance with the meeting minutes when the utterance of the first participant is not ongoing at the time of receipt of the wait request.

4. The meeting support system according to claim 1, wherein the terminal comprises:
an operation unit, transmitting the wait request to the meeting support device.

5. A meeting support method for a meeting support system comprising a meeting support device used by a first participant and a terminal used by a second participant, the meeting support method comprising:
acquiring utterance information of the first participant by an acquisition unit of the meeting support device;
displaying at least the utterance information of the first participant by a display unit of the meeting support device; and
determining whether an utterance of the first participant is interrupted by a processing unit of the meeting support device when receiving a wait request from the terminal, and changing display of the display unit by the processing unit of the meeting support device according to the wait request when it is determined that the utterance of the first participant is interrupted.

6. A non-transitory computer-readable medium storing a program for a computer of a meeting support device in a meeting support system, the meeting support system comprising the meeting support device and a terminal, the meeting support device having a display unit and being used by a first participant and the terminal being used by a second participant, wherein the program causes the computer to:
acquire utterance information of the first participant,
display at least the utterance information of the first participant,
determine whether an utterance of the first participant is interrupted when receiving a wait request from the terminal, and
change display of the display unit according to the wait request when it is determined that the utterance of the first participant is interrupted.
